(19) United States
(12) Patent Application Publication
(10) Pub. No.: US 2002/0116197 A1
(43) Pub. Date: Aug. 22, 2002

(54) Audio visual speech processing

(76) Inventor: Gamze Erten, Okemos, MI (US)

Correspondence Address: Mark D. Chuey, Brooks & Kushman P.C., 1000 Town Center, 22nd Floor, Southfield, MI, 48075-1351, US

(21) Appl. No.: 09/969,406

(22) Filed: Oct. 1, 2001

Related U.S. Application Data
(60) Provisional application No. 60/236,720, filed on Oct. 2, 2000.

(51) Int. Cl. G10L 21/00

(52) U.S. Cl. 704/273

(57) ABSTRACT

Recognizing and enhancing speech is accomplished by fusing audio and visual speech recognition. An audio speech recognizer determines a subset of speech elements for speech segments received from at least one audio transducer. A visual speech recognizer determines a figure of merit for at least one speech element based on at least one image received from at least one visual transducer. Speech may also be enhanced by variably filtering or editing received audio signals based on at least one visual speech parameter.

### CROSS-REFERENCE TO RELATED APPLICATION

This application claims the benefit of U.S. provisional application Serial No. 60/236,720, filed Oct. 2, 2000, which is incorporated herein by reference in its entirety.

### BACKGROUND OF THE INVENTION

1. Field of the Invention

The present invention relates to enhancing and recognizing speech.

2. Background Art

Speech is an important part of interpersonal communication. In addition, speech may provide an efficient input for man-machine interfaces. Unfortunately, speech often occurs in the presence of noise. This noise may take many forms such as natural sounds, machinery, music, speech from other people, and the like. Traditionally, such noise is reduced through the use of acoustic filters. While such filters are effective, they are frequently not adequate in reducing the noise content in a speech signal to an acceptable level.

Many devices have been proposed for converting speech signals into textual words. Such conversion is useful in man-machine interfaces, for transmitting speech through low bandwidth channels, for storing speech, for translating speech, and the like. While audio-only speech recognizers are increasing in performance, such audio recognizers still have unacceptably high error rates particularly in the presence of noise. To increase the effectiveness of speech-to-text conversion, visual speech recognition systems have been introduced. Typically, such visual speech recognizers attempt to extract features from the speaker such as, for example, geometric attributes of lip shape and position. These features are compared against previously stored models in an attempt to determine the speech. Some speech systems use outputs from both an audio speech recognizer and a visual speech recognizer in an attempt to recognize speech. However, the independent operation of the audio speech recognizer and the visual speech recognizer in such systems still fails to achieve sufficient speech recognition efficiency and performance.

What is needed is to combine visual cues with audio speech signals in a manner that enhances the speech signal and improves speech recognition.

### SUMMARY OF THE INVENTION

The present invention combines audio signals that register the voice or voices of one or more speakers with video signals that register the image of faces of these speakers. This results in enhanced speech signals and improved recognition of spoken words.

A system for recognizing speech spoken by a speaker is provided. The system includes at least one visual transducer views the speaker. At least one audio transducer receives the spoken speech. An audio speech recognizer determines a subset of speech elements for at least one speech segment received from the audio transducers. The subset includes speech elements that are more likely than other speech elements to represent the speech segment. A visual speech recognizer receives at least one image from the visual transducers corresponding to a particular speech segment. The subset of speech elements from the audio speech recognizer corresponding to the particular speech segment is also received. The visual speech recognizer determines a figure of merit expressing a likelihood that each speech element in the subset of speech elements was actually spoken by the speaker based on the at least one received image.

In an embodiment of the present invention, decision logic determines a spoken speech element for each speech segment based on the subset of speech elements from the audio speech recognizer and on at least one figure of merit from the visual speech recognizer.

In another embodiment of the present invention, the visual speech recognizer implements at least one model, such as a hidden Markov model (HMM), for determining at least one figure of merit. The model may base decisions on at least one feature extracted from a sequence of frames acquired by the visual transducers.

In yet another embodiment of the present invention, the visual speech recognizer represents speech elements with a plurality of models. The visual speech recognizer limits the set of models considered when determining figures of merit to only those models representing speech elements in the subset received from the audio speech recognizer.

One or more various techniques may be used to determine the figure of merit. The visual speech recognizer may convert signals into a plurality of visemes. Geometric features of the speaker's lips may be extracted from a sequence of frames received from the visual transducers. Visual motion of lips may be determined from a plurality of frames. At least one model may be fit to an image of lips received from the visual transducers.

Speech elements may be defined at one or more of a variety of levels. These include phonemes, words, phrases, and the like.

A method for recognizing speech is also provided. A sequence of audio speech segments is received from a speaker. For each audio speech segments, a subset of possible speech elements spoken by the speaker is determined. The subset includes a plurality of speech elements most probably spoken by the speaker during the audio speech segment. At least one image of the speaker corresponding to the audio speech segment is received. At least one feature is extracted from at least one of the images. The most likely speech element is determined from the subset of speech elements based on the extracted feature.

In an embodiment of the present invention, a video figure of merit may be determined for each speech element of the subset of speech elements. An audio figure of merit may also be determined. A spoken speech segment may then be determined based on the audio figures of merit and the video figures of merit.

A system for enhancing speech spoken by a speaker is also provided. At least one visual transducer views the speaker. At least one audio transducer receives the spoken speech. A visual recognizer estimates at least one visual speech parameter for each segment of speech. A variable filter filters output from at least one audio transducer. The variable filter has at least one parameter value based on the estimated visual speech parameter.

In an embodiment of the present invention, the system also includes an audio speech recognizer generating speech representations based on filtered audio transducer output.

In another embodiment of the present invention, the system includes an audio speech recognizer generating a subset of possible speech elements. The visual speech recognizer estimates at least one visual speech parameter based on the subset of possible speech elements generated by the audio speech recognizer.

A method of enhancing speech from a speaker is also provided. At least one image of the speaker is received for a speech segment. At least one visual speech parameter is determined for the speech segment based on the images. An audio signal is received corresponding to the speech segment. The audio signal is variably filtered based on the determined visual speech parameters.

A method of detecting speech is also provided. At least one visual cue about a speaker is used to filter an audio signal containing the speech. A plurality of possible speech elements for each segment of the speech is determined from the filtered audio signal. The visual cue is used to select among the possible speech elements.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram illustrating possible audio visual speech recognition paths in humans;

FIG. 2 is a block diagram illustrating a speech recognition system according to an embodiment of the present invention;

FIG. 3 illustrates a sequence of visual speech language frames;

FIG. 4 is a block diagram illustrating visual model training according to an embodiment of the present invention;

FIG. 5 is a block diagram illustrating visual model-based recognition according to an embodiment of the present invention;

FIG. 6 illustrates viseme extraction according to an embodiment of the present invention;

FIG. 7 illustrates geometric feature extraction according to an embodiment of the present invention;

FIG. 8 illustrates lip motion extraction according to an embodiment of the present invention;

FIG. 9 illustrates lip modeling according to an embodiment of the present invention;

FIG. 10 illustrates lip model extraction according to an embodiment of the present invention;

FIG. 11 is a block diagram illustrating speech enhancement according to an embodiment of the present invention;

FIG. 12 illustrates variable filtering according to an embodiment of the present invention;

FIG. 13 is a block diagram illustrating speech enhancement according to an embodiment of the present invention;

FIG. 14 is a block diagram illustrating speech enhancement according to an embodiment of the present invention;

FIG. 15 is a block diagram illustrating speech enhancement preceding audio visual speech detection according to an embodiment of the present invention; and

FIG. 16 is a block diagram illustrating speech enhancement through editing according to an embodiment of the present invention.

### DETAILED DESCRIPTION OF THE PREFERRED EMBODIMENTS

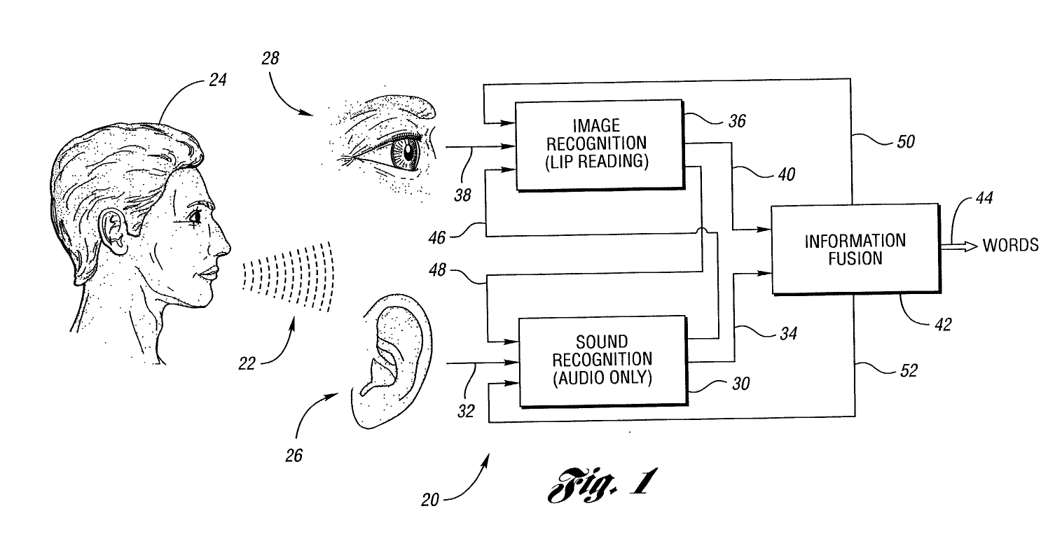

Referring to FIG. 1, a block diagram illustrating possible audio visual speech recognition paths in humans is shown. A speech recognition model, shown generally by 20, suggests how speech 22 from speaker 24 may be perceived by a human. Auditory system 26 receives and interprets audio portions of speech 22. Visual system 28 receives and interprets visual speech information such as lip movement and facial expressions of speaker 24.

The speech recognition models for human audio visual processing of speech put forth by this invention include sound recognizer 30 accepting sound input 32 and generating audio recognition information 34. Image recognizer 36 accepting visual input 38 and producing visual recognition information 40. Information fusion 42 accepts audio recognition information 34 and visual recognition information 40 to generate recognized speech information 44 such as, for example, spoken words.

Speech recognition model 20 includes multiple feedback paths for enhancing perception. For example, audio recognition information 46 may be used by image recognizer 36 in visual speech recognition. Likewise, visual recognition information 48 may be used by sound recognizer 30 to improve audio recognition. In addition, recognized speech information 50,52 may be used by image recognizer 36 and sound recognizer 30, respectively, to improve speech recognition.

One indicator that feedback plays a crucial role in understanding speech is the presence of bimodal effects where the perceived sound can be different from the sound heard or seen when audio and visual modalities conflict. For example, when a person hears \ba\ and sees speaker 24 saying \ga\, that person perceives a sound like \da\. This is called the McGurk effect. The effect also exists in reverse, where the results of visual speech perception can be affected by dubbed audio speech.

The present invention exploits these perceived feedbacks in the human speech recognition process. Various embodiments utilize feedback between audio and visual speech recognizers to enhance speech signals and to improve speech recognition.

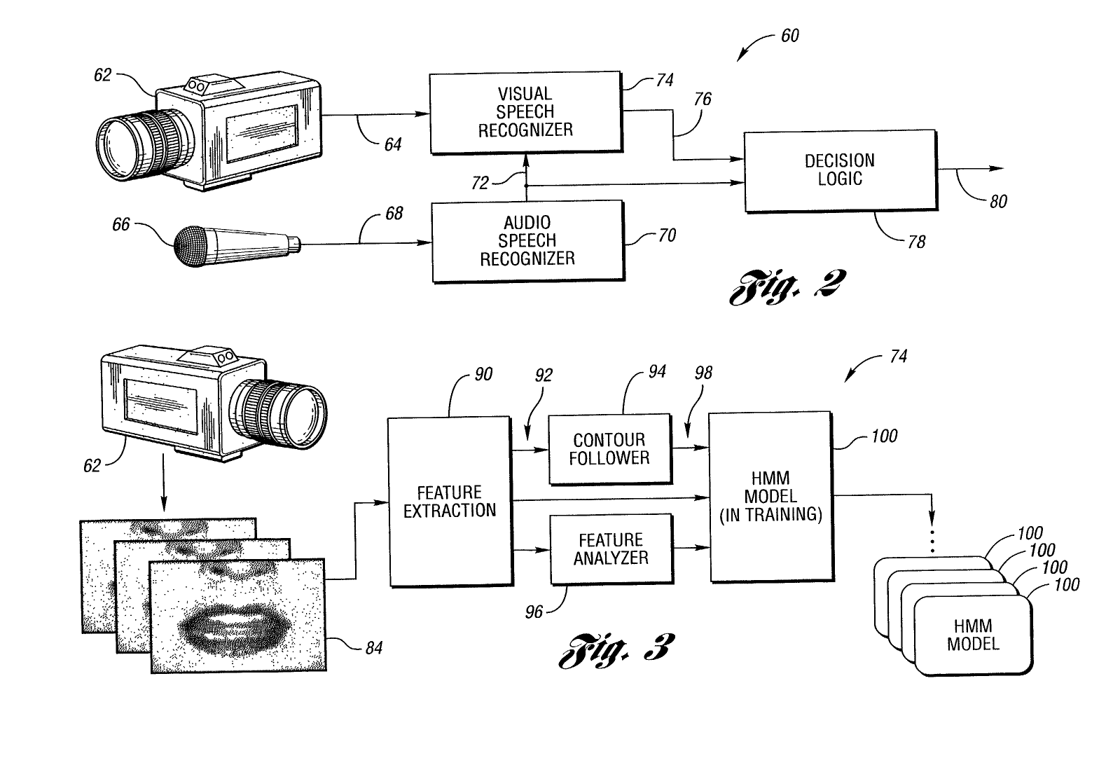

Referring now to FIG. 2, a block diagram illustrating a speech recognition system according to an embodiment of the present invention is shown. A speech recognition system, shown generally by 60, includes one or more visual transducers 62 viewing speaker 24. Each visual transducer 62 generates visual images 64. Visual transducer 62 may be a commercial off-the-shelf camera that may connect, for example, to the USB port of a personal computer. Such a system may deliver color images 64 and programmable frame rates of up to 30 frames/second. In an exemplary system, images 64 were delivered as frames at 15 frames per second, 320×240 pixels per frame, and 24 bits per pixel. Other types of visual transducers 62 may also be used, such as, for example, grayscale, infrared, ultraviolet, X-ray, ultrasound, and the like. More than one visual transducer 62 may be used to acquire images of speaker 24 as speaker 24 changes position, may be used to generate a three-dimensional view of speaker 24, or may be used to acquire different types of images 64. One or more of visual transducers 62 may have pan, tilt, zoom, and the like to alter viewing angle or image content.

Speech recognition system 60 also includes one or more audio transducers 66, each generating audio speech signals 68. Typically, audio transducers 68 is a microphone pointed in the general direction of speaker 24 and having sufficient audio bandwidth to capture all or most relevant portions of speech 22. Multiple transducers 66 may be used to obtain sufficient signal as speaker 24 changes position, to improve directionality, for noise reduction, and the like.

Audio speech recognizer 70 receives audio speech signals 68 and extracts or recognizes speech elements found in segments of audio speech signals 68. Audio speech recognizer 70 outputs speech element subset 72 for speech segments received. Subset 72 includes a plurality of speech elements that are more likely than those speech elements excluded from the subset to represent speech 22 within the speech segment. Speech elements include phonemes, words, phrases, and the like. Typically, audio speech recognizer 70 may recognize thousands of speech elements. These speech elements may be trained or preprogrammed such as, for example, by training or preprogramming one or more models.

Audio speech recognizer 70 may be able to extract a single speech element corresponding to the speech segment with a very high probability. However, audio speech recognizer 70 typically selects a small subset of possible speech elements for each segment. For example, audio speech recognizer 70 may determine that a spoken word within the speech segment was “mat” with 80% likelihood and “nat” with 40% likelihood. Thus, “mat” and “nat” would be in subset 72. As will be recognized by one of ordinary skill in the art, the present invention applies to a wide variety of audio speech recognizers 70 that currently exist in the art.

Visual speech recognizer 74 receives at least one image 64 corresponding to a particular speech segment. Visual speech recognizer 74 also receives subset of speech elements 72 from audio speech recognizer 70 corresponding to the particular speech segment. Visual speech recognizer 74 generates visual speech element information 76 based on the received images 64 and subset 72. For example, visual speech recognizer 74 may determine a figure of merit expressing a likelihood that each speech element or a portion of each speech element in subset of speech elements 72 was actually spoken by speaker 24. This figure of merit could be a simple binary indication as to which speech element in subset 72 was most likely spoken by speaker 24. Visual speech element information 76 may also comprise weightings for each speech element or a portion of each speech element in subset 72 such as a percent likelihood that each element in subset 72 was actually spoken. Furthermore, a figure of merit may be generated for only certain speech elements or portions of speech elements in subset 72. It is also possible that figures of merit generated by visual speech recognizer 74 are used within visual speech recognizer 74 such as, for example, to form a decision about speech elements in subset 72.

Visual speech recognizer 74 may use subset 72 in a variety of ways. For example, visual speech recognizer 74 could represents speech elements with a plurality of models. This representation may be, for example, a one-to-one correspondence. In one embodiment, visual speech recognizer 74 may limit the models considered to only those models representing speech elements in subset 72. This may include restricting consideration to only those speech elements in subset 72, to only those models obtained from a list invoked given subset 72, and the like.

Visual speech element information 76 may be used as the determination of speech elements spoken by speaker 24. Alternatively, decision logic 78 may use both visual speech element information 76 and speech element subset 72 to generate spoken speech output 80. For example, both visual speech element information 76 and speech element subset 72 may contain weightings indicating the likelihood that each speech element in subset 72 was actually spoken by speaker 24. Decision logic 78 determines spoken speech 80 by comparing the weightings. This comparison may be preprogrammed or may be trained.

Referring now to FIG. 3, a block diagram illustrating visual model training according to an embodiment of the present invention is shown. There are two parts to visual speech recognition. The first part is a training phase which involves training each speech element to be recognized. The second part is a recognition phase which involves using models trained in the training phase to recognize speech elements.

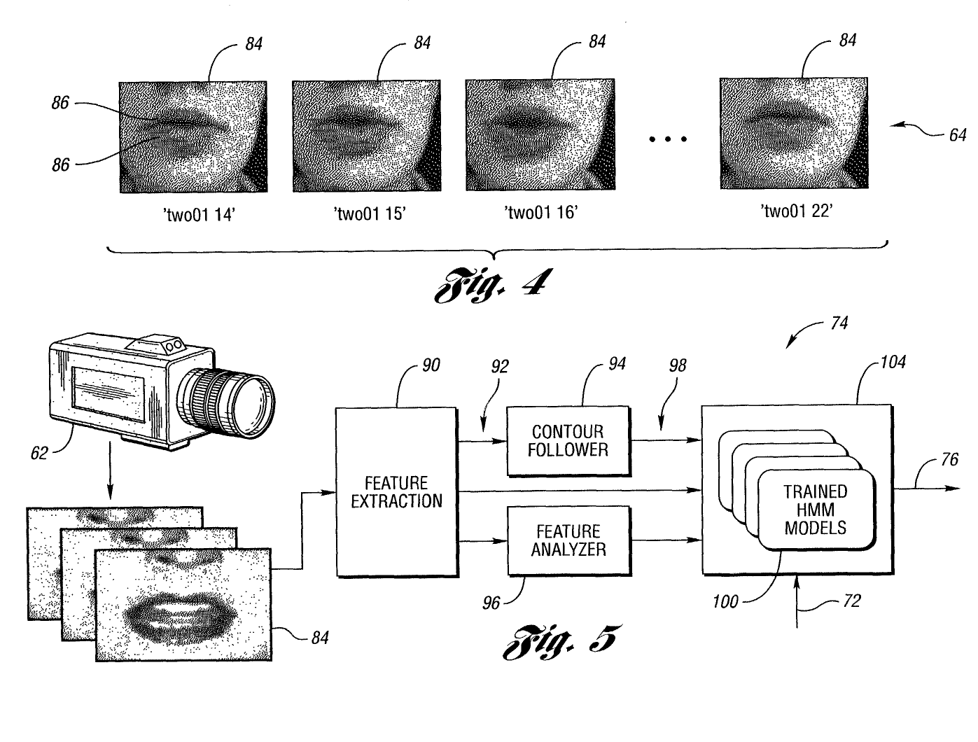

For training, speaker 24 prepares for capturing images 64 by positioning in front of one or more visual transducers 62. As illustrated in FIG. 4, image 64 typically includes a sequence of frames 84 capturing the position of lips 86 of speaker 24. Frames 84 are delivered to feature extractor 90. Feature extractor 90 extracts one or more features 92 representing attributes of lips 86 in one or more frames 84. Various feature extraction techniques are described below.

Features 92 may be further processed by contour follower 94, feature analyzer 96, or both. Contour following and feature analysis place features 92 in context. Contour following may reduce the number of pixels that must be processed by extracting only those pixels relevant to the contour of interest. Feature analyzer 96 compares results of current features 92 to previous features 92 to improve feature accuracy. This may be accomplished by simple algorithms such as smoothing and outlier elimination or by more complicated predictive routines. The outputs of contour follower 94 and feature analyzer 96 as well as features 92 may serve as model input 98. In training, model input 98 helps to construct each model 100. Typically, each speech element will have a model 100.

In an embodiment of the present invention, visual speech recognizer 74 implements at least one hidden Markov model (HMM) 100. Hidden Markov models are statistical models typically used in pattern recognition. Hidden Markov models include a variety of parameters such as the number of states, the number of possible observation symbols, the state transition matrix, the observation probability density function, the initial state probability density function, and the set of observation symbols.

Three fundamental problems are solved in order to use HMMs for pattern recognition. First, given model 100, the probability of an observation space must be calculated. This is the fundamental task of recognition. Second, given model 100, the optimal state sequence which maximizes the joint probability of the state sequence and the observation sequence must be found. This is the fundamental task of initialization. Third, model 100 must be adjusted so as to maximize the probability of the observation sequence. This is the fundamental task of training.

Hidden Markov model 100 is created for each speech element in the vocabulary. For example, the vocabulary may be trained to recognize each digit for a telephone dialer. A training set of images consisting of multiple observations is used to initialize each model 100. The training set is brought through feature extractor 90. The resulting features 92 are organized into vectors. These vectors are used, for example, to adjust parameters of model 100 in a way that maximizes the probability that the training set was produced by model 100.

Typically, HMM implementation consists of routines for code book generation, training of speech elements and recognition of speech elements. Construction of a code book is done before training or recognition is performed. A code book is developed based on random observations of each speech element in the vocabulary of visual speech recognizer 74. Once a training set for the code book has been constructed, the training set must be quantized. The result of quantization is the code book which has a number of entries equal to the number of possible observation symbols. If the models used by visual recognizer 74 are restricted in some manner based on subset 72 received, a different code book may be used for each model set restriction.

Training may be accomplished once all observation data for training of each necessary speech element has been collected. Training data may be read from files appended to either a manual or an automated feature extraction process. This results in a file containing an array of feature vectors. These features are quantized using a suitable vector quantization technique.

Once the training sequences are quantized, they are segmented for use in the training procedure. Each set of observation sequences represents a single speech element which will be used to train model 100 representing that speech element. The observation sequence can be thought of as a matrix. Each row of the observation is a separate observation sequence. For example, the fifth row represents the fifth recorded utterance of the speech element. Each value within a row corresponds to a quantized frame 84 within that utterance. The utterances may be of different lengths since each utterance may contain a different number of frames 84 based on the length of time taken to pronounce the speech element.

Next, HMM models 100 are initialized prior to training. The number of states, the code book size, the model type, and the distribution. Typically, the Bakis model or left-right model is used. Also, typically, a uniform distribution is used.

Referring now to FIG. 5, a block diagram illustrating visual model-based recognition according to an embodiment of the present invention is shown. Visual transducer 62 views speaker 24. Frames 84 from visual transducer 62 are received by feature extractor 90 which extracts features 92. If used, contour follower 94 and feature analyzer 96 enhance extracted features 92 in model input 98. If feature analyzer 96 implements a predictive algorithm, feature analyzer 96 may use previous subsets 72 to assist in predictions. Model examiner 104 accepts model input 98 and tests models 100.

The set of models 100 considered may be restricted based on subset 72. This restriction may include only those speech elements in subset 72, only those speech elements in a list based on subset 72, and the like. Furthermore, the set of models 100 considered may have been trained only on models similarly restricted by subset 72. Testing of models 100 amounts to visual speech recognition in the context of generating one or more figures of merit for speech elements of subset 72. Thus, the output of model examiner 104 is visual speech element information 76.

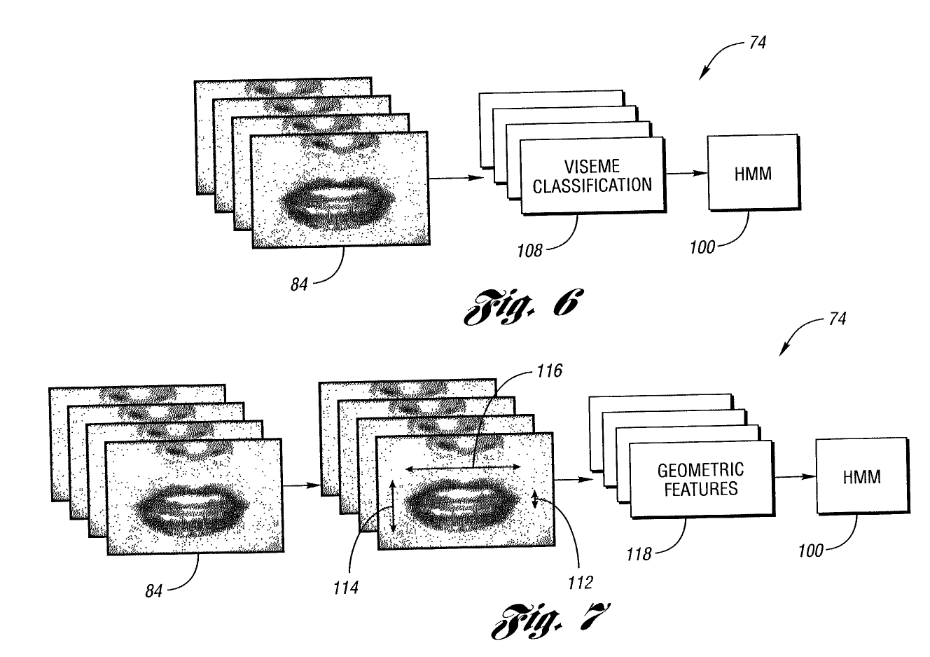

Referring now to FIG. 6, image-based extraction according to an embodiment of the present invention is shown. In image-based approaches, pixel values or transformations or functions of pixel values, in either grayscale or color images, are used to obtain features. Each image must be classified before training or recognition is performed. For example, one or more frames 84 may be classified into viseme 108. One or more visemes 108 may be used to train model 100 and, subsequently, may be applied to each model 100 for speech element recognition. Alternatively, viseme classification may be a result of the HMM process. Models 100 may also involve visemes in context such as, for example, compositions of two or more visemes.

Referring now to FIG. 7, geometric feature extraction according to an embodiment of the present invention is shown. Geometric-based features are physical measures or values of physical or geometric significance which describe the mouth region. Such features include outer height of the lips, inner height of the lips, width of the lips, and mouth perimeter and mouth area. For example, each frame 84 may be examined for lips inner height 112, lips outer height 114, and lips width 116. These measurements are extracted as geometric features 118 which are used to train models 100 and for recognition with models 100.

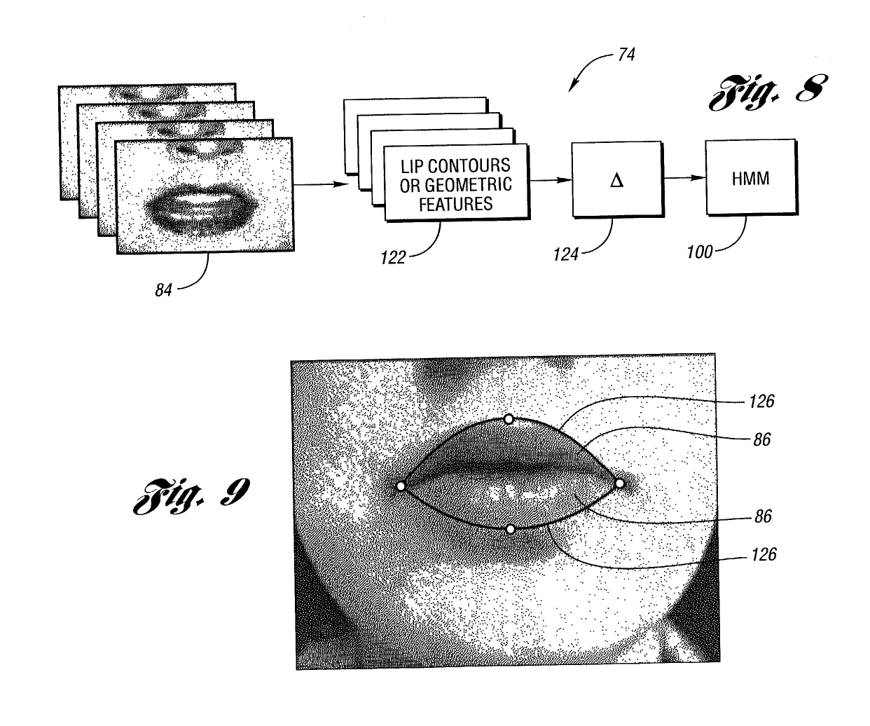

Referring to FIG. 8, lip motion extraction according to an embodiment of the present invention is shown. In a visual motion-based approach, derivatives or differences in sequences of mouth images, various transforms or geometric features yield information about movement of lip contours. For example, lip contours or geometric features 122 are extracted from frames 84. Derivative or differencing operation 124 produces information about lip motions. This information is used to train models 100 or for recognition with models 100.

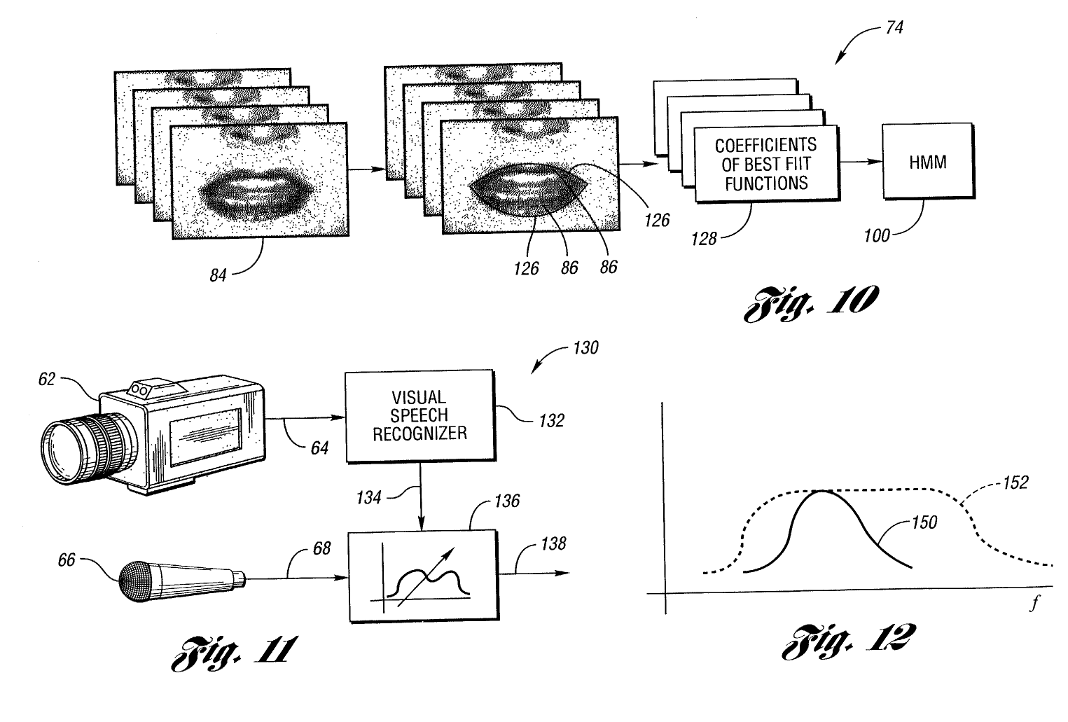

Referring now to FIG. 9, lip modeling according to an embodiment of the present invention is shown. In a model-based approach, a template is used to track the lips. Various types of models exist including deformable templates, active contour models or snakes, and the like. For example, deformable templates deform to the lip shape by minimizing an energy function. The model parameters illustrated in FIG. 9 describe two parabolas 126.

Referring now to FIG. 10, a block diagram illustrating lip model extraction according to an embodiment of the present invention is shown. Each frame 84 is examined to fit curves 126 to lips 86. Model parameters or curves of best fit functions 128 describing curves 126 are extracted. Model parameters 128 are used to train models 100 or for recognition with models 100.

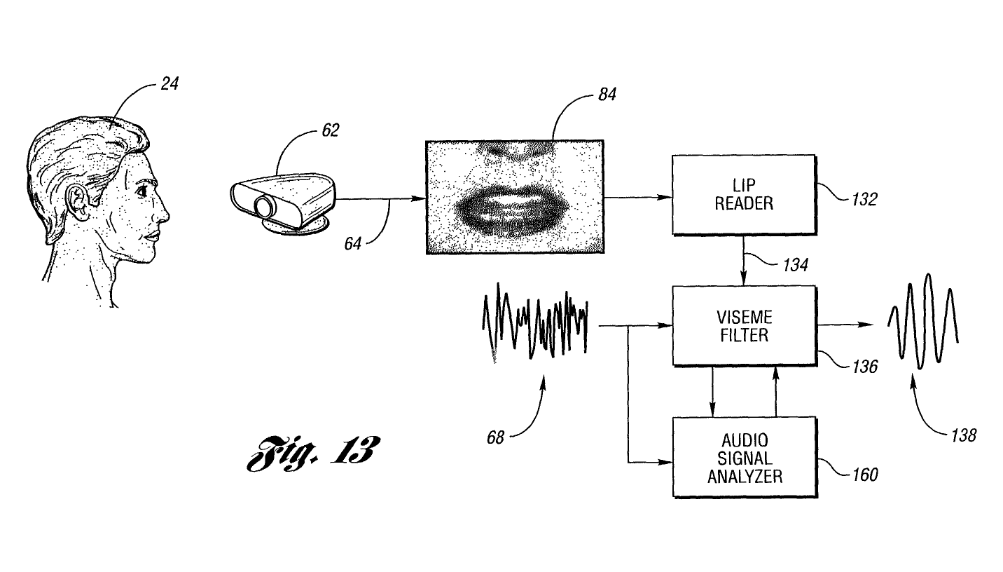

Referring now to FIG. 11, a block diagram illustrating speech enhancement according to an embodiment of the present invention is shown. A speech enhancement system, shown generally by 130, includes at least one visual transducer 62 with a view of speaker 24. Each visual transducer 62 generates image 64 of speaker 24 including visual cues of speech 22. Visual speech recognizer 132 receives images 64 and generates at least one visual speech parameter 134 corresponding to at least one segment of speech. Visual speech recognizer 132 may be implemented in a manner similar to visual speech recognizer 74 described above. In this case, visual speech parameter 134 would include one or more recognized speech elements. In other embodiments, visual speech recognizer 132 may output as visual speech parameter 134 one or more image-based feature, geometric-based feature, visual motion-based feature, model-based feature, and the like.

Speech enhancement system 130 also includes one or more audio transducers 66 producing audio speech signals 68. Variable filter 136 filters audio speech signals 68 to produce enhanced speech signals 138. Variable filter 136 has at least one parameter value based on visual speech parameter 134.

Visual speech parameter 134 may work to affect one or more changes to variable filter 136. For example, visual speech parameter 134 may change one or more filter bandwidth, filter cut-off frequency, filter gain, and the like. Various constructions for filter 136 are also possible. Filter 136 may include one or more of at least one discrete filter, at least one wavelet-based filter, a plurality of parallel filters with adaptive filter coefficients, time-adaptive filters that concatenate individual discrete filters, a serially-arranged bank of filters implementing a cochlea inner ear model, and the like.

Referring now to FIG. 12, variable filter according to an embodiment of the present invention is shown. Variable filter 136 switches between filters with two different frequency characteristics. Narrowband characteristic 150 may be used to filter vowel sounds whereas wideband characteristic 152 may be used to filter consonants such as “t” and “p” which carry energy across a wider spectral range.

Another possible filter form uses visemes as visual speech parameter 134. For example, visemes may be used to distinguish between consonants since these are the most commonly misidentified portions of speech in the presence of noise. A grouping of visemes for English consonants is listed in the following table.

| Viseme Group | Phoneme(s) |
|---|---|
| 1 | f, v |
| 2 | th, dh |
| 3 | s, z |
| 4 | sh, zh |
| 5 | p, b, m |
| 6 | w |
| 7 | r |
| 8 | g, k, n, t, d, y |
| 9 | l |

Initially, each viseme group will have a single unique filter. This creates a one-to-many mapping between visemes and represented consonants. Ambiguity arising from the many-to-one mapping of phonemes to visemes can be resolved by examining speech audio signal 68 or 138. If a single filter improves the intelligibility of speech for all consonants represented by that filter, it is not necessary to determine which phoneme was uttered in visual speech recognizer 132. If no such filter can be found, then other factors such as the frequency content of audio signal 68 may be used to select among several possible filters or filter parameters.

One tool that may be used to accomplish this selection is fuzzy logic. Fuzzy logic and inference techniques are powerful methods for formulation of rules in linguistic terms. Fuzzy logic defines overlapping membership functions so that an input data point can be classified. The input is first classified into fuzzy sets, and often, an input is a member of more than a single set. The membership in a set is not a hard decision. Instead, membership in a set is defined to a degree, usually between zero and one. The speech content can be studied to determine the rules that apply. Note that the same set of fuzzy inference can be employed to combine a set of filter to varying degrees as well. This way, when selective between filters or setting parameters in variable filter 136 is not clear, variable filter 136 does not end up making an incorrect decision, but rather permits a human listener or speech recognizer to resolve the actual word spoken from other cues or context.

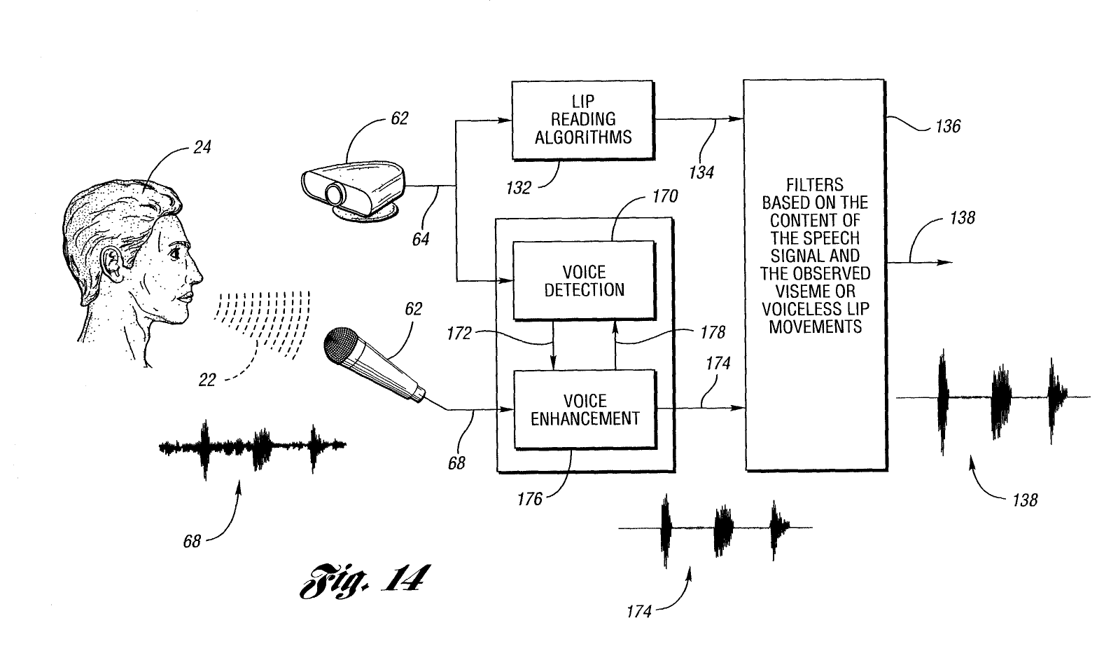

Referring now FIG. 13, a block diagram illustrating speech enhancement according to an embodiment of the present invention is shown. Visual transducer 62 outputs images 64 of the mouth of speaker 24. These images are received as frames 84 by visual speech recognizer 132 implementing one or more lip reader techniques such as described above. Visual speech recognizer 132 outputs visemes as visual speech parameters 134 to variable filter 136. Variable filter 136 filters audio speech signals 68 to produce enhanced speech signals 138.

Variable filter 160 may also receive information or in part depend upon data from audio signal analyzer 160, which scans audio signal 68 for speech characteristics such as, for example, changes in frequency content from one speech segment to the next, zero crossings, and the like. Variable filter 136 may be specified by visual speech parameters 134 as well as by information from audio signal analyzer 136.

Referring now to FIG. 14, a block diagram illustrating speech enhancement according to an embodiment of the present invention is shown. In this embodiment, two levels of speech enhancement is obtained. Visual transducer 62 forwards image 64 of speaker 24 to audio visual voice detector 170. Audio visual voice detector 170 uses the position of lips of speaker 24 as well as attributes of audio signal 68 provided by voice enhancement signal 178 to determine whether speaker 24 is speaking or not. Voice enhancement signal 178 may be, for example, speech element subset 72. Speech detect signal 172 produced by audio visual voice detector 170 operates to pass or attenuate audio signal 68 from audio transducer 66 to produce intermediate speech signal 174 from voice enhancer 176. Alternatively or concurrently, voice detector 170 may apply attributes of intermediate speech signal 174, enhance speech signal 138 or both in generating speech detect signal 172. Voice enhancement may include inputs for noise reduction, noise cancellation, and the like, in addition to speech detect signal 172.

Image 64 is also received by visual speech recognizer 132 which produces visual speech parameter 134. Variable filter 136 produces enhanced speech signal 138 from intermediate speech signal 174 by adjusting one or more filter parameters based on visual speech parameter 134.

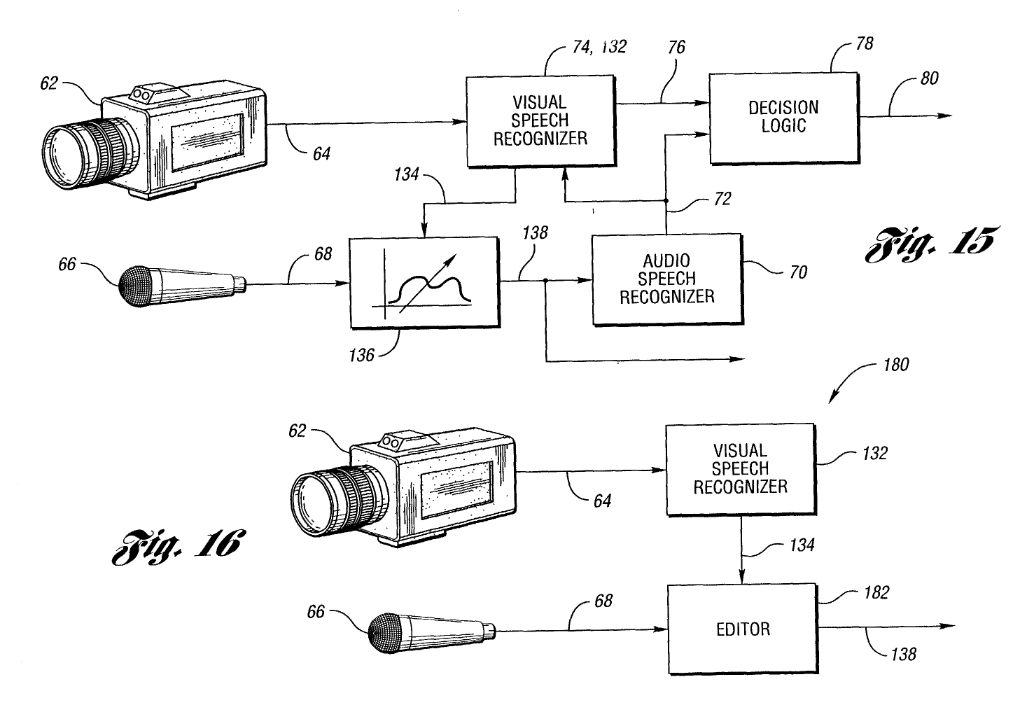

Referring now to FIG. 15, a block diagram illustrating speech enhancement preceding audio visual speech detection according to an embodiment of the present invention is shown. Visual speech recognizer 74,132 receives images 64 from visual transducer 62. Visual speech recognizer 74,132 uses at least one visual cue about speaker 24 to generate visual parameter 134. Variable filter 136 uses visual parameter 134 to filter audio signals 68 from audio transducer 66 generating enhanced speech signal 138. Audio speech recognizer 70 uses enhanced speech signal 138 to determine a plurality of possible speech elements for each segment of speech in enhanced speech signal 138. Visual speech recognizer 74,132 selects among the plurality of possible speech elements 72 based on at least one visual cue. Decision logic 78 may use selection 76 and speech elements 72 to generate spoken speech 80.

Visual speech recognizer 74,132 may use the same or different techniques for generating visual parameters 134 and possible speech element selections 76. Visual speech recognizer 74,132 may be a single unit or separate units. Further, different transducers 62 or images 64 may be used to generate visual parameters 134 and selections 76.

Referring now to FIG. 16, a block diagram illustrating speech enhancement according to an embodiment of the present invention is shown. A speech enhancement system, shown generally by 180, is similar to speech enhancement system 130 with editor 182 substituted to variable filter 136. Editor 182 performs one or more editing operations on audio signal 68 to generate enhanced speech signal 138. Editing functions include cutting out a segment of audio signal 68, replacing a segment of audio signal 68 with a previously recorded or synthesized audio signal, superposition of another audio segment upon a segment of audio signal 68, and the like. In effect, editor 182 permits visual speech recognizer 132 to repair or replace audio signal 68 in certain situations such as, for example, in the presence of high levels of audio noise. Editor 182 may replace or augment variable filter 136 in any of the embodiments described above.

While embodiments of the invention have been illustrated and described, it is not intended that these embodiments illustrate and describe all possible forms of the invention. The words of the specification are words of description rather than limitation, and it is understood that various changes may be made without departing from the spirit and scope of the invention.

What is claimed is:

1. A system for recognizing speech spoken by a speaker comprising:
at least one visual transducer with a view of the speaker;
at least one audio transducer receiving the spoken speech;
an audio speech recognizer in communication with the at least one audio transducer, the audio speech recognizer determining a subset of speech elements for at least one speech segment received from the at least one audio transducer, the subset including a plurality of speech elements more likely to represent the speech segment; and
a visual speech recognizer in communication with the at least one visual transducer and the audio speech recognizer, the visual speech recognizer operative to:
(a) receive at least one image from the at least one visual transducer corresponding to a particular speech segment;
(b) receive the subset of speech elements from the audio speech recognizer corresponding to the particular speech segment; and
(c) determine a figure of merit for at least one of the subset of speech elements based on the at least one received image.

2. A system for recognizing speech as in claim 1 further comprising decision logic in communication with the audio speech recognizer and the visual speech recognizer, the decision logic determining a spoken speech element for each speech segment based on the subset of speech elements from the audio speech recognizer and on at least one figure of merit from the visual speech recognizer.

3. A system for recognizing speech as in claim 1 wherein the visual speech recognizer implements at least one hidden Markov model for determining at least one figure of merit.

4. A system for recognizing speech as in claim 3 wherein the hidden Markov model bases decisions on at least one feature extracted from at least one image acquired by the at least one visual transducer.

5. A system for recognizing speech as in claim 1, the visual speech recognizer converting signals received from the at least one visual transducer into at least one viseme, wherein at least one figure of merit is based on the at least one viseme.

6. A system for recognizing speech as in claim 1, the visual speech recognizer extracting at least one geometric feature from each of a sequence of frames received from the at least one visual transducer, wherein at least one figure of merit is based on the at least one extracted geometric feature.

7. A system for recognizing speech as in claim 1, the visual speech recognizer determining visual motion of lips of the speaker from a plurality of frames received from the at least one visual transducer, wherein at least one figure of merit is based on the determined lip motions.

8. A system for recognizing speech as in claim 1, the visual speech recognizer fitting at least one model to an image of lips received from the at least one visual transducer, wherein the at least one figure of merit is based on the at least one fitted model.

9. A system for recognizing speech as in claim 1 wherein at least one speech element comprises a phoneme.

10. A system for recognizing speech as in claim 1 wherein at least one speech element comprises a word.

11. A system for recognizing speech as in claim 1 wherein at least one speech element comprises a phrase.

12. A system for recognizing speech as in claim 1 wherein the visual speech recognizer represents speech elements with a plurality of models, the visual speech recognizer limiting the models considered to determine the figures of merit to only those models representing speech elements in the subset received from the audio speech recognizer.

13. A method for recognizing speech from a speaker, the method comprising:
receiving a sequence of audio speech segments from the speaker;
for each of at least one of the audio speech segments, determining a subset of possible speech elements most probably spoken by the speaker during the audio speech segment;
receiving at least one image of the speaker corresponding to the audio speech segment;
extracting at least one feature from the at least one image of the speaker; and
determining the most likely speech element from the subset of speech elements based on the at least one extracted feature.

14. A method for recognizing speech as in claim 13 wherein determining the most likely speech element comprises determining a video figure of merit for at least one speech element.

15. A method for recognizing speech as in claim 14 further comprising:
determining an audio figure of merit for each speech segment based on the audio speech segment; and
determining a spoken speech segment based on the audio figures of merit and the video figures of merit.

16. A method for recognizing speech as in claim 13 wherein determining the most likely speech element is based on at least one hidden Markov model.

17. A method for recognizing speech as in claim 13 wherein extracting at least one feature comprises determining at least one viseme.

18. A method for recognizing speech as in claim 13 wherein extracting at least one feature comprises extracting at least one geometric feature from at least one speaker image.

19. A method for recognizing speech as in claim 13 wherein extracting at least one feature comprises determining motion of the speaker in a plurality of frames.

20. A method for recognizing speech as in claim 13 wherein extracting at least one feature comprises determining at least one model fit to at least one region of the speaker's face.

21. A method for recognizing speech as in claim 13 wherein at least one speech element comprises a phoneme.

22. A method for recognizing speech as in claim 13 wherein at least one speech element comprises a word.

23. A method for recognizing speech as in claim 13 wherein at least one speech element comprises a phrase.

24. A method for recognizing speech as in claim 13 wherein the visual speech recognizer represents speech elements with a plurality of models, determining the most likely speech element from the subset of speech elements comprises considering only those visual speech recognizer models representing speech elements in the subset received from the audio speech recognizer.

25. A system for enhancing speech spoken by a speaker comprising:
at least one visual transducer with a view of the speaker;
at least one audio transducer receiving the spoken speech;
a visual speech recognizer in communication with the at least one visual transducer, the visual speech recognizer estimating at least one visual speech parameter for each segment of speech; and
a variable filter filtering output from at least one of the audio transducers, the variable filter having at least one parameter value based on the at least one estimated visual speech parameter.

26. A system for enhancing speech as in claim 25 wherein the at least one speech parameter comprises at least one viseme.

27. A system for enhancing speech as in claim 25 wherein the variable filter comprises at least one discrete filter.

28. A system for enhancing speech as in claim 25 wherein the variable filter comprises at least one wavelet-based filter.

29. A system for enhancing speech as in claim 25 wherein the variable filter comprises a plurality of parallel filters with adaptive filter coefficients.

30. A system for enhancing speech as in claim 25 wherein the variable filter comprises a serially arranged bank of filters implementing a cochlea inner ear model.

31. A system for enhancing speech as in claim 25 wherein the variable filter changes at least one filter bandwidth based on the at least one visual speech parameter.

32. A system for enhancing speech as in claim 25 wherein the variable filter changes at least one filter cut-off frequency based on the at least one visual speech parameter.

33. A system for enhancing speech as in claim 25 wherein the variable filter changes at least one filter gain based on the at least one visual speech parameter.

34. A system for enhancing speech as in claim 25 further comprising an audio speech recognizer in communication with the variable filter, the audio speech recognizer generating speech representations based on the at least one filtered audio transducer output.

35. A method of enhancing speech from a speaker comprising:
receiving a sequence of images of the speaker for a speech segment;
determining at least one visual speech parameter for the speech segment based on the sequence of images;
receiving an audio signal corresponding to the speech segment; and
variably filtering the received audio signal based on the determined at least one visual speech parameter.

36. A method of enhancing speech as in claim 35 wherein determining at least one visual speech parameter comprises determining a viseme.

37. A method of enhancing speech as in claim 35 wherein variable filtering comprises changing at least one filter bandwidth based on the at least one visual speech parameter.

38. A method of enhancing speech as in claim 35 wherein variable filtering comprises changing at least one filter gain based on the at least one visual speech parameter.

39. A method of enhancing speech as in claim 35 wherein variable filtering comprises changing at least one filter cut-off frequency based on the at least one estimated visual speech parameter.

40. A method of enhancing speech as in claim 35 further comprising generating a speech representation based on the variably filtered audio signal.

41. A method of enhancing speech from a speaker comprising:
receiving a sequence of images of the speaker for a speech segment;
determining at least one visual speech parameter for the speech segment based on the sequence of images;
receiving an audio signal corresponding to the speech segment; and
editing the received audio signal based on the determined at least one visual speech parameter.

42. A method of enhancing speech as in claim 41 wherein editing comprises cutting out at least a section of the audio signal.

43. A method of enhancing speech as in claim 41 wherein editing comprises inserting a section of speech into the audio signal.

44. A method of enhancing speech as in claim 41 wherein editing comprises superposition of another audio section upon a section of the audio signal.

45. A method of enhancing speech as in claim 41 wherein editing comprises replacing a section of the audio signal with another audio section.

46. A method of detecting speech comprising:
using at least one visual cue about a speaker to filter an audio signal containing the speech;
determining a plurality of possible speech elements for each segment of the speech from the filtered audio signal; and
selecting among the plurality of possible speech elements based on the at least one visual cue.

47. A method of detecting speech as in claim 46 wherein the at least one visual cue comprises at least one viseme.

48. A method of detecting speech as in claim 46 wherein the at least one visual cue comprises extracting at least one geometric feature from at least one speaker image.

49. A method of detecting speech as in claim 46 wherein the at least one visual cue comprises determining speaker motion in a plurality of image frames.

50. A method of detecting speech as in claim 46 wherein the at least one visual cue comprises determining at least one model fit to at least one speaker image.

51. A method of detecting speech as in claim 46 wherein the at least one visual cue used to filter the audio signal is different from the at least one visual cue for selecting among possible speech elements.
